(19) United States
(12) Patent Application Publication
(10) Pub. No.: US 2007/0214881 A1
(43) Pub. Date: Sep. 20, 2007

(54) LIQUID LEVEL DETECTION DEVICE AND THE METHOD THEREOF

(76) Inventors: HSI-MING SHU, TAIPEI (TW); Feng-Yi Peng, Taipei (TW)

Correspondence Address: G. LINK CO., LTD., 3550 BELL ROAD, MINOOKA, IL, 60447, US

(21) Appl. No.: 11/684,988

(22) Filed: Mar. 12, 2007

(30) Foreign Application Priority Data
Mar. 15, 2006 (TW) 095108671

(51) Int. Cl. G01F 23/00

(52) U.S. Cl. 73/295

(57) ABSTRACT

The present invention provides a liquid level detection device for detecting the liquid level height of liquid fuel in a chamber, which has an inner space connected with the chamber. The liquid level detection device comprises: a heater, which is configured in the inner space of the liquid level detection device, and is used to heat the liquid fuel in the inner space; at least one temperature sensors, which are configured in the inner space of the liquid level detection device, and is used to measure the temperature of the liquid fuel in the inner space; and, a liquid level calculation device, which receives the temperature signals of the liquid fuel measured by these temperature sensors, and calculates the temperature variation rate of the liquid fuel, and converts into the liquid level height of the liquid fuel in the chamber according to the temperature variation rate.

### FIELD OF THE INVENTION

The present invention relates to a liquid level detection device, and particularly is used to detect the liquid fuel volume accommodated in a liquid fuel supply device.

### BACKGROUND OF THE INVENTION

Fuel cell is a power generation device by directly converting the chemical energy stored in fuel and oxidant into electric energy through electrode reaction. There are a lot of types of fuel cell with various classification methods. Differentiating by the characteristics of electrolyte, there are five different types of electrolyte fuel cells, i.e. alkaline fuel cell, phosphoric acid fuel cell, proton exchange membrane fuel cell, molten carbonate fuel cell, and solid oxide fuel cell; wherein the proton exchange membrane fuel cell further comprises the so-called direct methanol fuel cell, which employs the methanol as the fuel, without transforming into hydrogen, and is one of the developed techniques having higher energy, and its applications include the large-scale power plant, mobile generator, and portable power supply, etc.

However, those types of liquid fuel cells, such as direct methanol fuel cell, have to overcome a problem in the commercialization process, that is the stability of power output. Thus, in the system design for liquid fuel cell, the liquid fuel volume accommodated in the liquid fuel supply device must be maintained within reasonable range to prevent the occurrence of fuel shortage causing the liquid fuel cell not being able to supply the normal power. Therefore, it is required to provide a liquid level detection device to measure the liquid fuel volume accommodated in the liquid fuel supply device anytime, i.e. detecting the liquid level height of the liquid fuel in the liquid fuel supply device, so as to ensure the liquid level height to be maintained within a default standard range, and maintain the supply quality of the fuel cell, and the electronic product will not be damaged by the instability of power supply from the fuel cell.

### SUMMARY OF INVENTION

The main object of the present invention is to provide a liquid level detection device for fuel cell, which is used to monitor if the liquid fuel volume required by the fuel cell is enough, so that when there is a shortage of liquid fuel volume, there will be a response immediately.

To this end, the present invention provides a liquid level detection device for detecting the liquid level height of liquid fuel in a chamber, which has an inner space connected with the chamber. The liquid level detection device comprises: a heater, which is configured in the inner space of the liquid level detection device, and is used to heat the liquid fuel in the inner space; at least one temperature sensors, which are configured in the inner space of the liquid level detection device, and is used to measure the temperature of the liquid fuel in the inner space; and, a liquid level calculation device, which receives the temperature signals of the liquid fuel measured by these temperature sensors, and calculates the temperature variation rate of the liquid fuel, and converts into the liquid level height of the liquid fuel in the chamber according to the temperature variation rate.

### BRIEF DESCRIPTION OF DRAWINGS

The above objective and advantages of the present invention will become more apparent with reference to the appended drawings wherein:

FIG. 1A is a structural diagram of an embodiment for the liquid level detection device according to the present invention;

FIG. 1B is a structural diagram of a varied embodiment for the liquid level detection device in FIG. 1A;

FIG. 2 is a relation diagram between temperature and heating time for the liquid fuel within the inner space in FIG. 1A and FIG. 1B, respectively;

FIG. 3 is a flow chart of the liquid level detection method for the liquid fuel according to the present invention; and

FIG. 4 is a structural diagram of a further varied embodiment for the liquid level detection device in FIG. 1A.

### DETAILED DESCRIPTION OF THE INVENTION

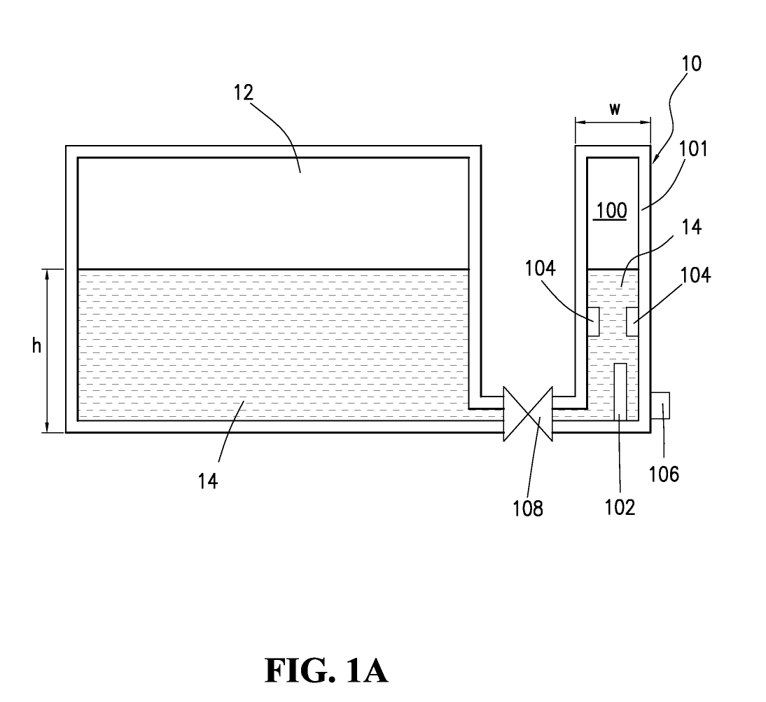

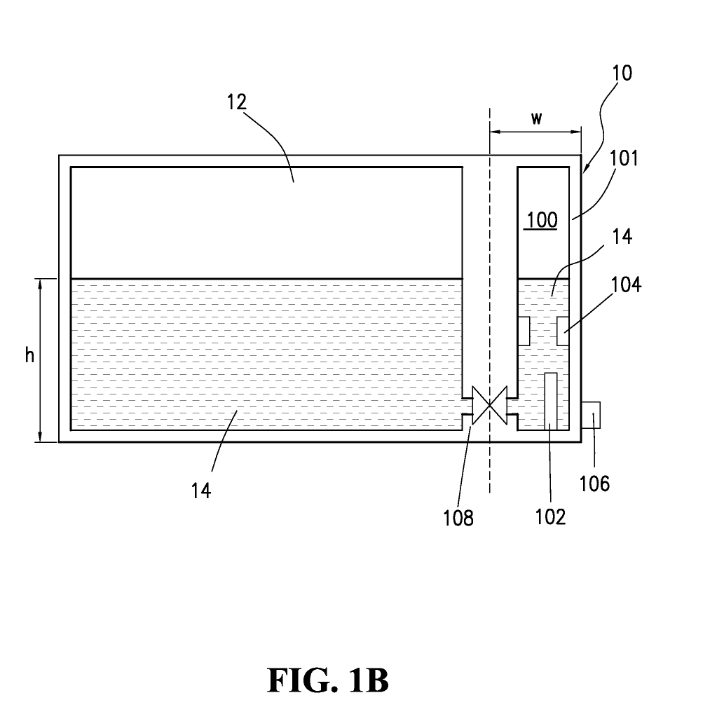

FIG. 1A is a structural diagram of an embodiment for the liquid level detection device according to the present invention. The liquid level detection device 10 according to the present invention is used to detect the liquid level height of the liquid fuel 14 within a chamber 12, and has an inner space 100 connected with the chamber 12; wherein, the chamber 12 is a liquid fuel supply tank for supplying the liquid fuel required by the fuel cell, and the liquid fuel 14 could be the methanol aqueous solution, or the pure methanol solution. Moreover, the inner space 100 is a space with a small volume, and the width W of the inner space 100 could be within 1 mm to 3 mm. Furthermore, as shown in FIG. 1A, the liquid level detection device 10 according to the present invention has a hollow shell 101, and the material of the hollow shell 101 could employ the heat insulation material, or could employ the heat insulation material enclosing the hollow shell 101, so as to retain the heat in the inner space 100, and prevent the heat inside the space, and also prevent the external interference affecting the temperature of the liquid fuel 14 in the inner space 100. Besides, the surface of the hollow shell 101 could be further treated with anti-erosion and/or anti-acid process.

Referring to FIG. 1A, the liquid level detection device 10 according to the present invention comprises: a heater 102, at least one temperature sensors 104, a liquid level calculation device 106, which are described respectively as follows:

The heater 102 is configured in the inner space 100 of the liquid level detection device for heating the liquid fuel 14. The heater 102 could employ the heating rod or heating wire, and the heater 102 could heat the liquid fuel 14 with a fixed heating power.

These temperature sensors 104 are configured in the inner space 100 of the liquid level detection device 10, which measure the temperature at different locations for the liquid fuel 14 in the inner space 100, respectively. The surface of the temperature sensor 104 could be further treated with anti-erosion and/or anti-acid process.

The liquid level calculation device 106 is used to receive the temperature signals of the liquid fuel 14 measured by these temperature sensors 104, and calculate the temperature variation rate of the liquid fuel 14, and convert to the liquid level height of the liquid fuel 14 in the chamber 12 according to the temperature variation rate. The liquid level calculation device 106 could employ the microprocessor as the component, and the liquid level calculation device 106 is electrically connected to these temperature sensors 104. Furthermore, the heater 102 could be electrically connected to the liquid level calculation device 106, and the heater 102 is controlled by the liquid level calculation device 106, so the heating power and heating time of the heater 102 could be controlled.

As shown in FIG. 1A, the liquid level detection device 10 according to the present invention could further comprise a control valve 108 for isolating the chamber 12 from the inner space 100 of the liquid level detection device 10; wherein, the control valve 108 could be electrically connected to the liquid level calculation device 106, and the control valve 108 is controlled by the liquid level calculation device 106. When the heater 102 has not yet heated the liquid fuel 14, the control valve 108 would be opened; however, when the liquid fuel 14 is under balance state, and the heater 102 is preparing to heat the liquid fuel 14, the control valve 108 would be closed; thus, it could improve the heating effect and efficiency of the heater 102 for the liquid fuel 14.

FIG. 1B is a structural diagram of a varied embodiment for the liquid level detection device in FIG. 1A; wherein, as shown in FIG. 1B, the liquid level detection device 10 according to the present invention is designed to be integrated with the chamber 12 as a whole, which is the only difference from FIG. 1A.

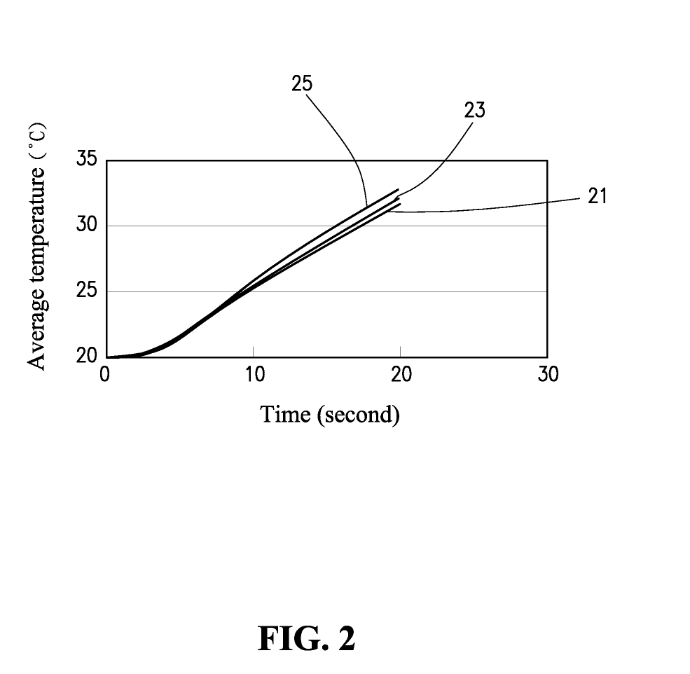

FIG. 2 is a relationship diagram of the temperature and the heating time for the liquid fuel in the inner space 100 in FIG. 1A and FIG. 1B. The heater 102, for example, employs the heating power at 0.5 W to continuously heat the liquid fuel 14. Referring to FIG. 2, the three curves 21, 23, 25 are indicating the relationship between the average temperature of the liquid fuel 14 measured by the these temperature sensors 104 and the heating time of the heater 102 with the liquid heights (h) at 10 cm, 5 cm, and 3 cm for three different liquid fuel. Please be noted that the slops (or so-called temperature variation rate) of three curves 21, 23, 25 are all different. The present invention is based on this physical characteristic, and by measuring the temperature variation rate for the liquid fuel 14 at that time, to convert to the liquid level height (h) of the liquid fuel 14 in the chamber 12.

As described, it is assumed that the average temperature for the liquid fuel 14 measured by these temperature sensors 104 at that time is 30° C.; next, the liquid level calculation device 106 would receive the temperature value (=30° C.), and further calculate the temperature variation rate as 0.625(° C./sec); then, the liquid level calculation device 106 could employ the pre-established experiment database (as shown in FIG. 2) to obtain the temperature variation rate at 0.625(° C./sec) as the linear slope for the liquid fuel level height (h) at 10 cm. Thus, the liquid level detection device 10 according to the present invention could convert the liquid level height (h) of the liquid fuel 14 at that time as 10 cm based on the temperature variation rate (=0.625° C./sec).

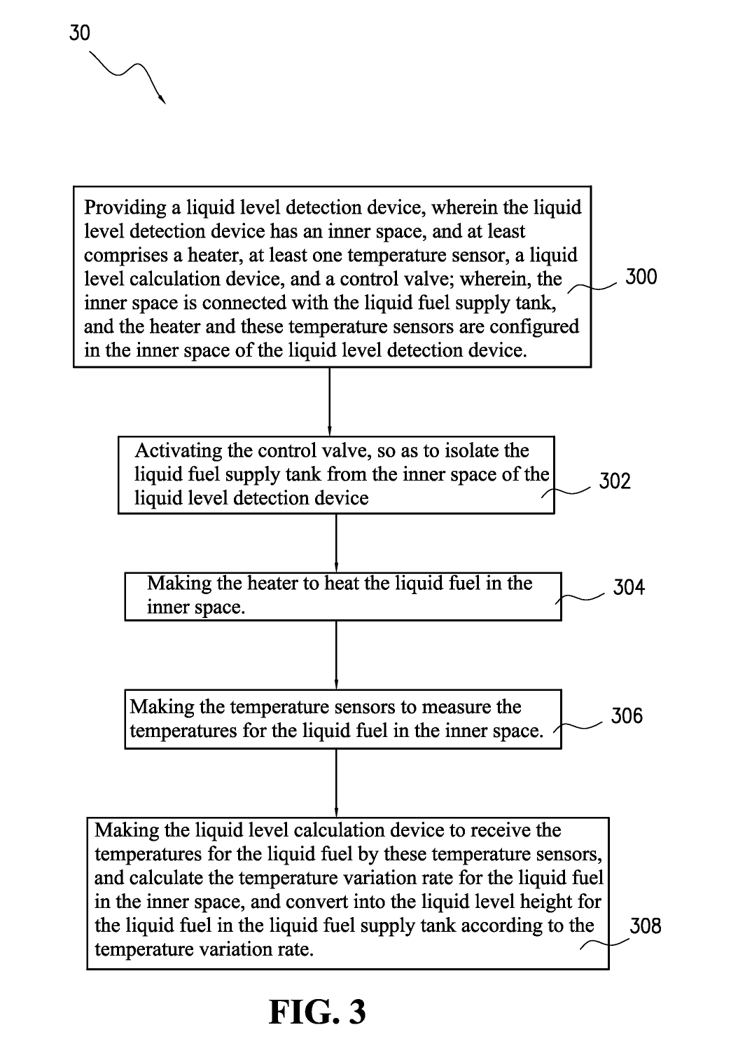

FIG. 3 is a flow chart of the liquid level detection method for the liquid fuel according to the present invention. The liquid level detection method 30 according to the present invention is used to detect the liquid level height (h) of the liquid fuel in the liquid fuel supply tank 12; wherein, the liquid fuel supply tank 12 is used to supply the liquid fuel required by the fuel cell, such as the methanol aqueous solution or pure methanol solution. The liquid level detection method 30 according to the present invention includes the step 300 to step 308. Please refer to the embodiments of FIG. 1A and FIG. 1B, which describe the method 30 according to the present invention as follows:

Step 300 is to provide the liquid level detection device 10, wherein the liquid level detection device 10 has an inner space 100, which comprises at least a heater 102, at least one temperature sensors 104, a liquid level calculation device 106, and a control valve; wherein, the inner space 100 is connected with the liquid fuel supply tank 12, and the heater 102 and these temperature sensors 104 are configured in the inner space 100 of the liquid level detection device 10.

Step 302 is to activate the control valve 108, so as to isolate the liquid fuel supply tank 12 from the inner space 100 of the liquid level detection device 10.

Step 304 is to make the heater 102 heating the liquid fuel 14 in the inner space 100; wherein, the heating power of the heater 102 is a fixed value; and, during heating, the liquid fuel 14 in the inner space 100 is static, so the heating energy could be completely absorbed by the liquid fuel 14 in the inner space, and the energy would not be dissipated by the flow of liquid fuel.

Step 306 is to make the temperature sensor 104 measuring the temperature for the liquid fuel 14 in the inner space 100. Step 308 is to make the liquid level calculation device 106 receiving the temperature signals for the liquid fuel 14 measured by these temperature sensors 104, and calculating the temperature variation rate of the liquid fuel 14 in the inner space 100, and converting to the liquid level height (h) of the liquid fuel 14 inside the liquid fuel supply tank 12 according to the temperature variation rate.

Furthermore, the liquid level detection method 30 according to the present invention is used to measure the temperature of the liquid fuel 14 in the inner space 100 more precisely, and further comprises: calculating the average temperature of the liquid fuel 14 measured by these temperature sensors 104 as the representative value for the temperature of the liquid fuel 14.

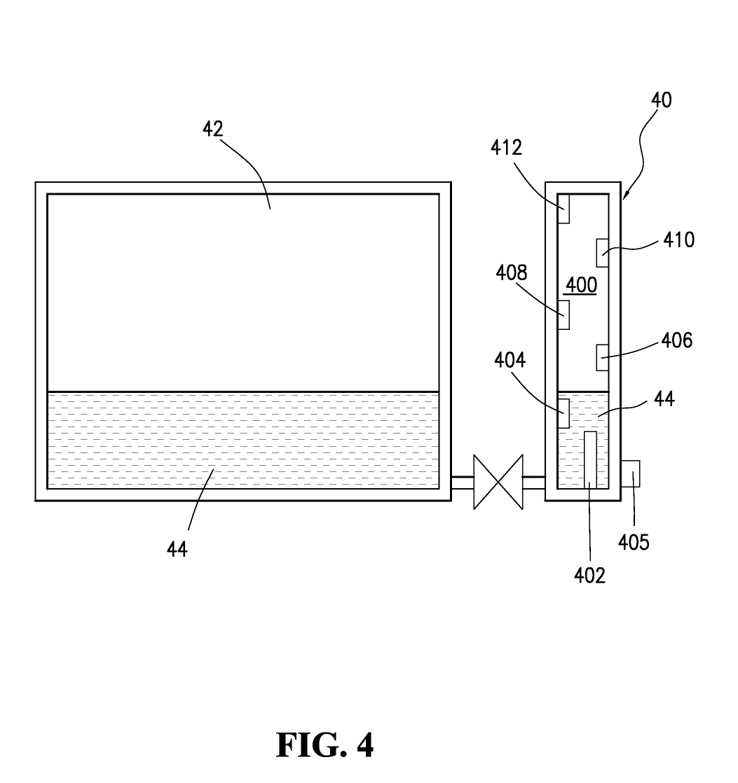

FIG. 4 is a structural diagram of another varied embodiment for the liquid level detection device in FIG. 1A. As shown in FIG. 4, the liquid level detection device 40 according to the present invention comprises: a heater 402, temperature sensors 404, 406, 408, 410, 412, and a liquid level calculation device 105, which are described as follows:

The heater 402 is configured in the inner space 400 of the liquid level detection device 40 for heating the liquid fuel 44. The heater 402 could employ the heating rod or heating wire; and, the heater 402 could employ the heating power at fixed value to heat the liquid fuel 44.

The temperature sensors 404, 406, 408, 410, 412 are configured in the inner space 400 of the liquid level detection device 40 for measuring the temperature at different locations for the liquid fuel 44 in the inner space 400. Moreover, these temperature sensors 404, 406, 408, 410, 412 are configured in the inner space 400 of the liquid level detection device 40 from the bottom of inner space 400 to the top of the inner space 400 with a pitch. Furthermore, the surfaces of the temperature sensors 404, 406, 408, 410, 412 could be further treated with anti-erosion and/or anti-acid process.

The liquid level calculation device 405 is to receive the temperature signals for the liquid fuel 44 measured by these temperature sensors 404, 406, 408, 410, 412, and calculate the temperature variation rate of the liquid fuel 44, and convert to the liquid level height of the liquid fuel 44 in the chamber 42 according to the temperature variation rate. Furthermore, the present invention could also employ the theory of having big difference between the temperatures measured by the temperature sensor below the liquid level and the temperature sensor above the liquid level, so that the liquid level calculation device 406 could further calculate the difference between temperatures from two neighbored temperature sensors in groups, and determine the liquid level height range of the liquid fuel in the chamber 42 based on the maximum among these differences. Making an example with FIG. 4, the inner space 400 of the liquid level detection device 40 is divided as five watermarks, and each section indicates 20% watermark. When the liquid level height of the liquid fuel 44 moves between the temperature sensors 404, 406, the liquid level calculation device 405 would calculate that the two temperatures for the liquid fuel 44 measured by the temperature sensors 404, 406 have the largest difference, and thus determine the liquid level height of the liquid fuel in the chamber 42 being at 20%˜40% watermark range.

Finally, the features and effects of the present invention could be summarized as follows:
1. The structure of the liquid level detection device according to the present invention is not so complicated, that the liquid level detection device according to the present invention could have lower manufacturing cost, and easy for mass production; and
2. The liquid level detection device according to the present invention could provide excellent response sensitivity on the measurement of liquid level height for the liquid fuel in the liquid fuel supply tank, and could monitor anytime whether the liquid level height of the liquid fuel falls within a default standard range, and further respond if the liquid fuel volume within the liquid fuel supply device is enough as the reference.

The present invention has been described as above. Thus, the disclosed embodiments are not limiting the scope of the present invention. And, for the skilled in the art, it is well appreciated that the change and modification without departing from the claims of the present invention should be within the spirit and scope of the present invention, and the protection scope of the present invention should be defined with the attached claims.

What is claimed is:

1. A liquid level detection device, for detecting the liquid level height of the liquid fuel in a chamber, which has an inner space connected to the chamber, and the liquid level detection device comprises:
a heater, which is configured in the inner space of the liquid level detection device, for heating the liquid fuel in the inner space;
at least one temperature sensors, which is configured in the inner space of the liquid level detection device, for measuring the temperature of the liquid fuel in the inner space;
a liquid level calculation device, which receives the temperature signals of the liquid fuel measured by these temperature sensors, and calculates the temperature variation rate of the liquid fuel, and converts to the liquid level height of the liquid fuel in the chamber.

2. The liquid level detection device according to claim 1, wherein these temperature sensors are configured in the inner space of the liquid level detection device from the bottom of the inner space to the top of the inner space with a pitch.

3. The liquid level detection device according to claim 2, wherein the liquid level calculation device would calculate the difference between the temperatures of two neighbored temperature sensors in groups, and determine the liquid level height range of the liquid fuel in the chamber based on the maximum among these differences.

4. The liquid level detection device according to claim 1, further comprises a control valve for isolating the chamber from the inner space of the liquid level detection device.

5. The liquid level detection device according to claim 1, wherein the heating power of the heater is at a fixed value.

6. The liquid level detection device according to claim 1, wherein the chamber is a liquid fuel supply tank for supply the liquid fuel required by a fuel cell.

7. The liquid level detection device according to claim 1, wherein the liquid fuel is a methanol aqueous solution.

8. The liquid level detection device according to claim 1, wherein the liquid fuel is a pure methanol solution.

9. The liquid level detection device according to claim 1, wherein the width of the inner space is between 1 mm and 3 mm.

10. The liquid level detection device according to claim 1, wherein the heater is a heating rod and/or heating wire.

11. The liquid level detection device according to claim 1, wherein the liquid level calculation device is a microprocessor.

12. The liquid level detection device according to claim 5, wherein the heating power of the heater is 0.5 W.

13. A liquid level detection device according to claim 1, wherein the liquid level detection device has a hollow shell, and the material of the hollow shell is an insulation material.

14. The liquid level detection device according to claim 13, wherein the surface of the hollow shell is treated with anti-erosion and/or anti-acid process.

15. The liquid level detection device according to claim 1, wherein the surface of the temperature sensor is treated with anti-erosion and/or anti-acid process.

16. A liquid level detection method, which is used to detect the liquid level height of the liquid fuel in a liquid fuel supply tank, wherein the liquid fuel supply tank is used to supply the liquid fuel required by a fuel cell, and the liquid level detection method comprises the following steps:
providing a liquid level detection device, and the liquid level detection device has an inner space, and at least comprises a heater, at least one temperature sensors, a liquid level calculation device, and a control valve, wherein the inner space is connected to the liquid fuel supply tank, and the heater and these temperature sensors are configured in the inner space of the liquid level detection device;
activating the control valve, for isolating the liquid fuel supply tank from the inner space of the liquid level detection device;
making the heater to heat the liquid fuel in the inner space;
making the temperature sensors to measure the temperature of the liquid fuel in the inner space; and
making the liquid level calculation device to receive the temperature signals of the liquid fuel measured by these temperature sensors, and calculate the temperature variation rate of the liquid fuel in the inner space, and convert to the liquid level height of the liquid fuel in the liquid fuel supply tank according to the temperature variation rate.

17. The liquid level detection method according to claim 16, further comprises: making the liquid level calculation device to calculate the average temperature of the liquid fuel measured by these temperature sensors as a representative value of the temperature of the liquid fuel.

18. The liquid level detection method according to claim 16, wherein the liquid fuel is a methanol aqueous solution.

19. The liquid level detection method according to claim 16, wherein the liquid fuel is a pure methanol solution.

20. The liquid level detection method according to claim 16, wherein the heating power of the heater is at a fixed value.
